(19) United States
(12) Patent Application Publication
(10) Pub. No.: US 2005/0248947 A1
(43) Pub. Date: Nov. 10, 2005

(54) Polymeric Anti-Dazzle Raster For Tubular Light Sources

(75) Inventor: Paolo Targetti, Firenze (IT)

Correspondence Address: Grant E. Pollack, Esq.;Steinberg & Raskin, P.C., 15th Floor, 1140 Avenue of the Americas, New York, NY, 10036-5803, US

(73) Assignee: Targetti Sankey S.p.A.

(21) Appl. No.: 10/622,913

(22) Filed: Jul. 16, 2003

(30) Foreign Application Priority Data
Jul. 19, 2002 (IT) FI2002U000077

(51) Int. Cl. F21V 1/00

(52) U.S. Cl. 362/317

(57) ABSTRACT

An anti-dazzle raster for tubular light sources is disclosed. The raster comprises, for example, at least two side pieces and a plurality of transverse partitions that extend between the pieces. The side pieces are made of a relatively rigid and resistant material and the partitions are grouped into modular units. Each unit includes a selected number of partitions connected to one another by at least two generally parallel connection bars and to the side pieces by a snap fit. The modular units are formed of a selected plastic material using injection molding.

### FIELD OF THE INVENTION

The present invention relates to an antidazzle raster for lighting fixtures making use of light sources that are tubular in shape, especially of the fluorescent type.

### DESCRIPTION OF THE PRIOR ART

As is known, the antidazzle rasters, with which the greater part of the lighting fixtures with tubular light sources of the aforementioned type are equipped with, are typically made of aluminium sheeting and are constituted by two side pieces, generally of an arcuate profile, that are parallel and diverge from opposite parts with respect to the median plane in which the light source is situated and by a plurality of transverse partitions mounted by means of a snap fit in appropriate notches provided in the side pieces. The partitions may have a V-shaped section with transverse flaps bent back towards the interior for stiffening purposes. These partitions have to be mounted one at a time on the side pieces of the raster, so that this type of antidazzle raster tends to be relatively costly.

A less costly solution envisages the manufacture of the antidazzle rasters in a plastic material by means of injection moulding. In this way the side pieces and the partitions are realized as a single piece, but necessarily the length of the raster realized in this way is less than that of a normal raster in aluminium due to reasons connected with the moulding operation. Rasters of this type are also less appreciable from an aesthetic point of view, because several modules have to be combined in order to cover the length of lighting fixtures of this type. In fact, the lengths of these fixtures normally vary from a minimum of 600 mm to a maximum of 1800 mm, whereas rasters in plastic material do not generally exceed a length of 600 mm. Furthermore, the individual modules have to be independently attached to the body of the lamp body, so that the structure is rendered more complex and the lamp replacement becomes more laborious.

### OBJECT AND SUMMARY OF THE INVENTION

The object of the present invention is to provide an antidazzle raster for tubular light sources that will not be associated with the assembling problems of metal rasters that have just been described and that, at one and the same time, will have adequate mechanical strength and will not give rise, as far as aesthetics are concerned, to the drawbacks associated with plastic rasters.

This aim is attained with the antidazzle raster in accordance with the present invention, which is characterized in that the side pieces are made of rigid and resistant material and that the partitions are grouped into modular units, each unit being formed by a certain number of partitions connected to each other by means of two parallel connection pieces and being attached by means of a snap fit to said side pieces, the modular unit being made of plastic material by means of injection moulding.

### BRIEF DESCRIPTION OF THE DRAWINGS

The invention will now be described in greater detail by means of the following description of an embodiment thereof, which is given purely by way of example and is not to be considered limitative in any way, said description making reference to the attached drawings, of which:

FIG. 1 shows a perspective view of a partition module for an antidazzle raster in accordance with the present invention;

FIG. 2 shows a perspective view of a portion of a neon lamp on which there is mounted the antidazzle raster in accordance with the invention;

FIG. 3 shows an exploded perspective view of the antidazzle raster in accordance with the present invention.

### DETAILED DESCRIPTION OF THE INVENTION

Referring to the above figures, the reference number 1 indicates the two side pieces of the antidazzle raster in accordance with the invention, made of aluminium sheeting, while 2 indicates a modular element made up of a certain number of parallel transverse partitions 3 set a constant distance apart and connected to each other by means of two bars 4. The partitions 3 and the bars 4 constitute a single piece made of plastic material, polycarbonate for example, by means of injection moulding.

Each transverse partition has a box-shaped configuration and a substantially V-shaped section with two symmetric shoulders 3a that extend from its upper edge 3b. The opposite internal faces 3c of each pair of shoulders 3a, together with the upper edge 3b of the respective partition, delimit a kind of channel in which there is accommodated the fluorescent lamp 5 shown only in FIG. 2. The bars 4, on the other hand, are attached to the outside faces 3d of the shoulders 3a of each partition 3. As is shown also in the figures, the side faces 3d are inclined in such a way that the two bars 4 come to lie in two planes of which the intersection is parallel to the axis of the fluorescent lamp.

The two side pieces 1 have a conventional arcuate profile that copies the lateral profile of the partitions 3. Both on the lateral edges of each of the partitions 3, in proximity of its lower end, there is provided a projecting tooth 6 that, on the occasion of assembling, is made to engage by means of a snap ft in a corresponding seating 7 arranged along a longitudinal edge 1a of each of the two side pieces 1. Once the modules 2 and the side pieces 1 have been assembled and attached to each other, the opposite longitudinal edge 1b of each of the side pieces 1 comes to engage beneath the bar 4 with a longitudinal groove 4a provided on the face not in view of said bar 4. Notches 8 are provided along the edge 1b of the side pieces 1 in positions corresponding to each partition 3, the width of the notches being equal to that of the shoulders 3a to permit the side pieces 1 to become engaged beneath the bars 4.

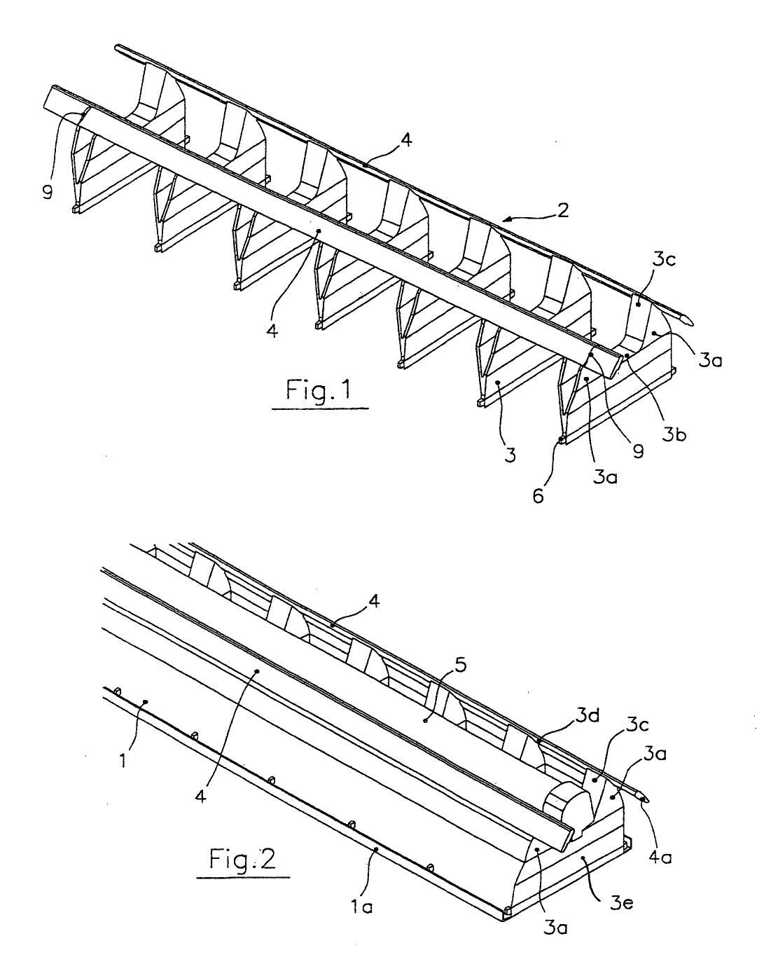

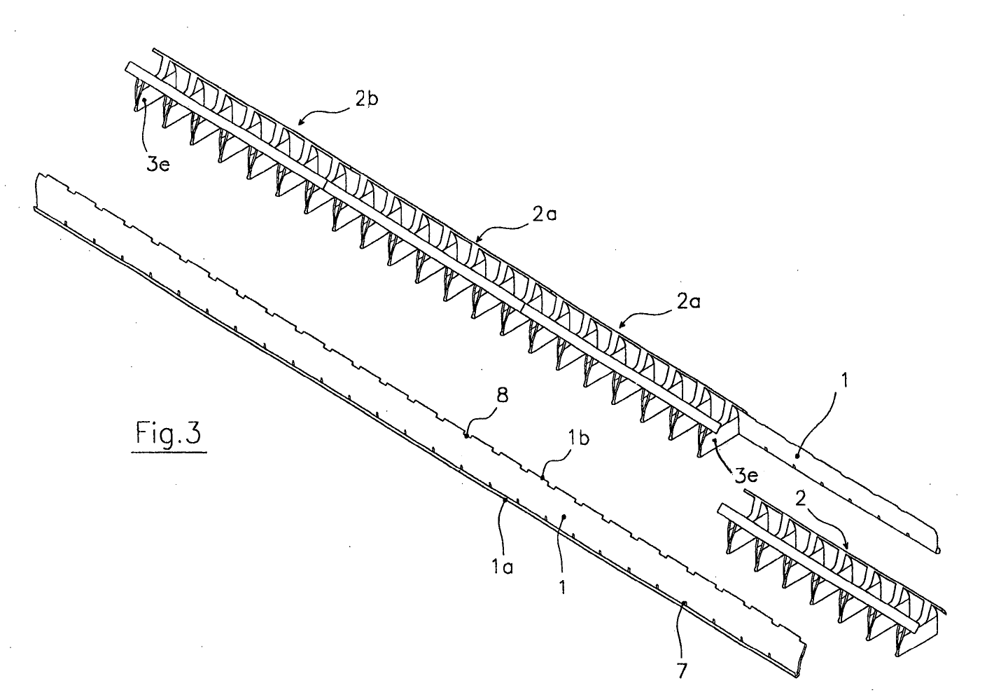

With a view to permitting the subsequent coupling of several modules 2 in order to realize an antidazzle raster of the desired length and maintain the same distance between the partitions also at the position of the joint between two adjacent modules, the bars 4 project beyond the terminal partitions 3 of each module by a length equal to half the distance between two partitions. Advantageously, at the beginning of the projecting part of each bar 4 there may be provided a tear-off line, indicated by 9 in FIG. 1, in order to facilitate the removal of the projecting part of the bar 4 from the terminal modules of the raster, thus permitting the application of a closure plug or some other accessory with equivalent functions. In this way it is also possible to use a single modular element both as intermediate module of the antidazzle raster and as terminal module after the projecting ends of the bars 4 have been removed.

Thanks to the solution provided by the present invention, the assembling operations are significantly simplified without worsening the aesthetics of the finished raster. In fact, in the assembling phase the partitions do not have to be mounted one at a time, but can rather be mounted in groups, while the external appearance of the raster will be that of a continuous surface, because each of its side pieces is realized as a single piece. Once it is mounted, moreover, the raster constitutes a single body and it is therefore easy to remove when, for example, the lamp has to be replaced.

1. An anti-dazzle raster for tubular light sources, the raster comprising a plurality of side pieces made of a generally rigid material and a plurality of transverse partitions extending between the side pieces, the partitions being grouped into modular units, wherein each unit includes a selected number of partitions connected to one another by a plurality of relatively parallel connection bars, and joined by snap fit engagement with the side pieces, the modular units being injection molded of a polymeric material.

2. The raster set forth in claim 1, wherein each partition has a substantially V-shaped section and a plurality of relatively symmetrical shoulders that extend from an upper edge of the partition, the connecting bars being affixed to outside faces of the shoulders.

3. The raster set forth in claim 1, wherein teeth extend from the partitions in a generally lateral direction suitable for snap fit engagement with corresponding seatings of the side pieces.

4. An anti-dazzle raster for tubular light sources the raster comprising a plurality of side pieces made of a generally rigid material and a plurality of transverse partitions extending between the side pieces, the partitions being grouped into modular units, wherein each unit includes a selected number of partitions connected to one another by a plurality of relatively parallel connection bars, and joined by snap fit engagement with the side pieces, the modular units being injection molded of a polymeric material, wherein the connection bars of each modular unit of partitions project beyond the partition ends a distance equal to about one-half the distance between two adjacent partitions.

5. An anti-dazzle raster for tubular light sources, the raster comprising a plurality of side pieces made of a generally rigid material and a plurality of transverse partitions extending between the side pieces, the partitions being grouped into modular units, wherein each unit includes a selected number of partitions connected to one another by a plurality of relatively parallel connection bars, and joined by snap fit engagement with the side pieces, the modular units beings injection molded of a polymeric material, wherein the connection bars of each nodular unit of partitions project beyond the partition ends a distance equal to about one-half the distance between two adjacent partitions and a tear-off line is provided at the root of the connection bars' projection portion in order to facilitate removal of the portion.
